(19) United States
(12) Patent Application Publication
(10) Pub. No.: US 2010/0126784 A1
(43) Pub. Date: May 27, 2010

(54) CONTINUOUSLY VARIABLE KNOB INPUT DEVICE

(75) Inventor: John G. Suddreth, Cave Creek, AZ (US)

Correspondence Address: HONEYWELL/IFL;Patent Services, 101 Columbia Road, P.O.Box 2245, Morristown, NJ, 07962-2245, US

(73) Assignee: HONEYWELL INTERNATIONAL INC., Morristown, NJ (US)

(21) Appl. No.: 12/323,833

(22) Filed: Nov. 26, 2008

(51) Int. Cl. G06F 3/041

(52) U.S. Cl. 178/18.01

(57) ABSTRACT

An input device includes a knob (102, 702) having a rigid material (110, 710) defining an axis and having a surface opposed to the axis. Touch sensing layers (108, 708) are disposed on the surface that sense the position of one or more fingers (120, 122, 124, 126) applied thereto, the touch sensing layers (108, 708) providing a sensed signal (404) indicative of the position of the fingers (120, 122, 124, 126). An electronic device (104, 406, 412, 416, 704) is coupled to receive the sensed signal (404) and provides a gain signal based on the position of the fingers (120, 122, 124, 126) on the touch sensing layers (108, 708).

### FIELD OF THE INVENTION

The present invention generally relates to user interfaces for electronic devices and more particularly to a continuously variable knob input device.

### BACKGROUND OF THE INVENTION

The market for electronic devices having user interfaces, for example, avionic equipment including radios and navigation equipment, computer monitors, televisions, cell phones, personal digital assistants (PDA's), digital cameras, and music playback devices, is very competitive. Manufactures are constantly improving their product with each model in an attempt to cut costs and production requirements.

In many electronic devices, data input devices, for example a knob (or dial), provide intuitive input from the user to data processing devices. Knobs are especially useful in electronic devices where other input devices typically occupy much more area. In communication devices, a knob may be used, for example, to adjust audio volume or visual intensity or change frequencies, or in navigation equipment to adjust a moving map.

Knobs typically are a material constructed of plastic, rubber, or metal that protrudes from a panel and that is shaped for easy grasp by the fingers and thumb of the user. Electrical circuitry coupled to the knob detects the movement of the knob or the end position of the knob after it has been rotated. This end position identifies the desired volume, intensity, or frequency, for example. In some known devices, the knob may be pushed to provide an on-off function.

Concentric duel knobs provide additional input from the user. Typically, the center knob protrudes further from the panel, so that either knob may be grasped by the user. The inner and outer knob of the concentric knobs may provide inputs for different selectable functions, or may provide a “course” and “fine” adjustment for the same desired function. However, the course and fine adjustment provided by these known knobs may not be calibrated for the ideal increments for a particular user or function.

Touch panels are another type of input device. There are many different types of touch panels, including capacitive, resistive, infrared, and surface acoustic wave. All of these technologies sense the position of touches on the device. The device generally includes a surface area across which a finger is moved to a desired position to identify a coordinate, for example, an item for selection.

It has been previously been disclosed in U.S. Pat. No. 6,492,979 to use a combination of capacitive touch screen and force sensors to prevent false touch. This disclosure however complicates the sensor interface and can not sense multiple touch forces at the same time. It has also been proposed in U.S. Pat. No. 7,196,694 to use force sensors at the peripherals of the touch screen to determine the position of a touch. This disclosure however does not offer a capability of multi-touch. It has been proposed in U.S. Pat. No. 7,321,361 to use a coordinate input device having a convex shape for providing such feedback to the user; however, the application of a force is sensed with a mechanical switch. Furthermore, touch screens occupy a large area on the electronic device.

Accordingly, it is desirable to provide a knob that senses the position of fingers thereon and may also sense force and movement of the fingers on the knob. Furthermore, other desirable features and characteristics of the present invention will become apparent from the subsequent detailed description and the appended claims, taken in conjunction with the accompanying drawings and this background.

### BRIEF SUMMARY OF THE INVENTION

An input device includes a knob having a rigid material defining an axis and having a surface opposed to the axis. Touch sensing layers are disposed on the surface that sense the position of one or more fingers applied thereto, the touch sensing layers providing a sensed signal indicative of the position of the fingers. An electronic device is coupled to receive the sensed signal and provides a gain signal based on the position of the fingers on the touch sensing layers.

### BRIEF DESCRIPTION OF THE DRAWINGS

The present invention will hereinafter be described in conjunction with the following drawing figures, wherein like numerals denote like elements, and

FIG. 1 is a cross sectional side view of a knob in accordance with a first exemplary embodiment;

FIG. 2 is a top cut away view of the first exemplary embodiment taken along line 2-2 of FIG. 1 having fingers placed thereon in a first position;

FIG. 3 is a perspective view of capacitive sensing layers as may be used with the first and second exemplary embodiments;

FIG. 4 is a block diagram of a device incorporating the exemplary embodiments;

FIG. 5 is a graph illustrating two inputs provided by the finger placement shown in FIGS. 2 and 6;

FIG. 6 is a top cut away view of the first exemplary embodiment taken along line 2-2 of FIG. 1 having fingers placed thereon in a second position;

FIG. 7 is a cross sectional side view of a knob in accordance with a second exemplary embodiment;

FIG. 8 is a side view of a knob in accordance with a third exemplary embodiment; and

FIG. 9 is a graph illustrating the input provided by the third exemplary embodiment of FIG. 8.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

The knob of the exemplary embodiments includes a plurality of force and movement sensing layers encasing a rigid material and is shaped to be grasped by one or more fingers and a thumb of a user. The layers determine the position of the fingers and thumb thereon, and in some embodiments, also senses the direction (of turn), speed and/or acceleration of finger movement, and pressure applied by the fingers, for determining the output signal. As the fingers are applied to the knob, the position, movement, and amount of pressure is sensed, for example, by a matrix of conductors in the sensing layers. In one embodiment, the knob is free of moving parts resulting in cost and reliability advantages over mechanical knobs. The input provided by the knob could select a function or have a fixed gain curve or a dynamic gain curve based on the active function. The shape of the knob could have a shape representative of the gain curve. Optionally, one of the sensing layers, preferably the one adjacent the fingers, may comprise a texture that varies in proportion to the amount of pressure, resulting in a variable degree of ease in which the fingers moves across the surface and providing feedback to the fingers.

This knob input device may be used in many types of electronic devices, including avionics equipment such as communication or navigation devices, computers, mobile devices such as a personal digital assistant (PDA), and the like.

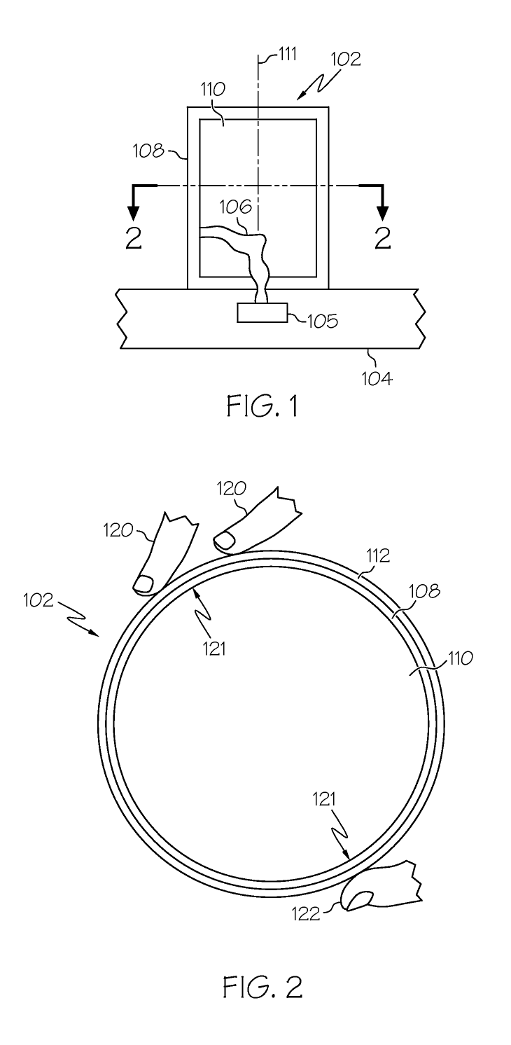

Referring to FIG. 1, a first exemplary embodiment includes a knob 102 securely disposed over an electronic device 104 and electronically coupled thereto by conductors 106. Circuit 105 within the electronic device 104 interprets a signal on conductors 106. Alternatively, the knob 102 may, for example, be deposed on a housing (not shown) in which the electronic device 104 resides. In accordance with the first exemplary embodiment, touch sensing layers 108 are disposed on the outer surface of the rigid material 110 of the knob 102 for detecting the placement of fingers on the knob 102 (as will be illustrated subsequently in FIG. 2). The rigid material 110 may be, for example, plastic, rubber, or metal.

There are many different types of touch sensing technologies, including capacitive, resistive, infrared, and surface acoustic wave. In some embodiments, it would be desirable to have a touch sensing device that not only senses the position of the touch, but also the force applied to the touch screen. Force sensing provides an extra dimension of freedom in inputting: it can simplify the input process by enabling different combinations of positions and forces on the knob 102. It also offers the possibility of discriminating against false touches by setting different force thresholds before a touch can register. An additional advantage is that force sensing is not limited to only finger touch as in the case of capacitive sensing, it also accept input from almost all other devices including gloves. It is also more tolerant to environmental noises such as EMI and dirt/oil on surface.

Referring to FIG. 2, a top cross sectional view taken along lines 2-2 of FIG. 1 shows the first exemplary embodiment of the knob 102 having movement and force sensing layers 108 formed over rigid material 110 of the knob 102. A protective layer 112 may be formed over the sensing layers 108 to protect the sensing layers 108 from scratching, dirt, and oil. The protective layer 112 may be any rigid material, but is preferably is a polymer.

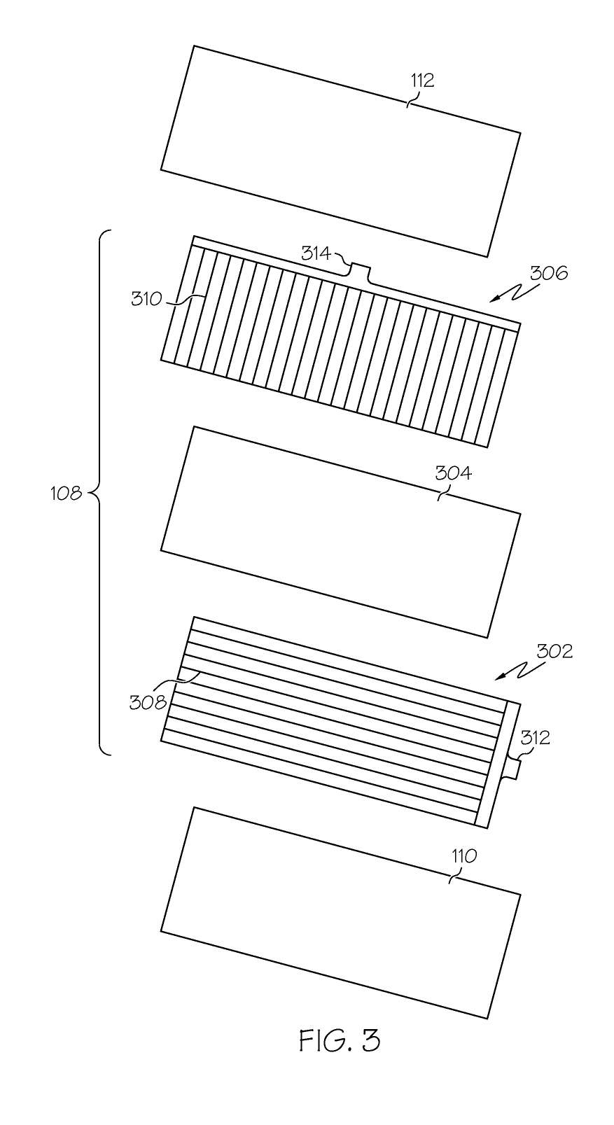

The sensing layers 108 may sense changes in, for example, capacitance, resistance, infrared, or surface acoustic wave characteristics. The exemplary embodiment shown in FIG. 3 senses changes in capacitance wherein the sensing layers 108 include conductive layers 302 and 306 separated by a dielectric layer 304. The conductive layers 302 and 306 each comprise a patterned plurality of adjacent but separated conductive traces 308 and 310, respectively. The conductive traces 308 are generally orthogonal to the conductive traces 310, providing a matrix of pixels, or a plurality of intersections, for sensing a capacitance therebetween. As fingers touch or move across the knob 102, the capacitance at each of the intersections of the traces 308, 310 experience a change in capacitance. The traces 308, 310 are preferably aligned in respective directions and have a pitch of 0.05-10 mm, (preferably 1.0 mm), a width less than the pitch but larger than 0.001 mm, a thickness of 1.0-1000 nm, (preferably 80 nm). The traces 308, 310 may be a conductive material, for example, indium tin oxide, zinc oxide, and tin oxide. A tab 312, 314 is electrically coupled to each trace 308, 310 for providing connection to circuitry 105.

Though various lithography processes, e.g., photolithography, electron beam lithography, imprint lithography, ink jet printing, may be used to fabricate the knob 102 and especially the patterned conductive traces 308, 310, a printing process is preferred. A variety of printing techniques, for example, Flexo, Gravure, Screen, and inkjet, may be used.

The sensing layers 108 also sense the pressure in a manner such as shown in U.S. Pat. Nos. 6,492,979 and 7,196,694, or in the document “Paper FSRs and Latex/Fabric Traction Sensors: Methods for the Development of Home-Made Touch Sensors”, by Rodolphe Koehly et al., Proceedings of the 2006 International Conference on New Interfaces for Musical Expression (NIME06), Paris, France, which are hereby incorporated by reference. For example, a conductive ink such as carbon black pigment may be mixed into a medium such as polyvinyl acetate, varnish, or liquid black inks.

By sensing this change in resistance due to pressure being applied to the sensing layers 108, the selection of modes, or functions, such as selecting a particular gain curve, may be accomplished. By scanning the rows and columns of the conductive traces and mapping the capacitance of the materials at each intersection, a corresponding map of the coordinate input device may be obtained. This map provides both the position and the force of the corresponding touch. The placing of multiple fingers on the screen can be distinguished, thus enabling greater freedom of inputting. The amount of force of the touch may be used, for example, as a variable gain on the input. A light touch may indicate a high gain on the position output, while a hard touch would indicate a lower gain on the position output. Additionally, the amount of force could be used as a z-axis position or as a zooming control.

A knob 102 generally is a material that rotates about an axis 111. The above embodiment allows for the sensing of finger placement and for movement of the fingers 120, 122 around the knob 102 (around the axis 111) without actual rotation of the knob 102 about the axis 111. Additional input may also be provided by movement of the fingers 120, 122 in a direction in a direction other than rotationally, for example, parallel with the axis 111, speed of the fingers 120, 122 in providing this movement, and different pressures exerted by the fingers 120, 122. All of these variables may be used to select or adjust information received by a user.

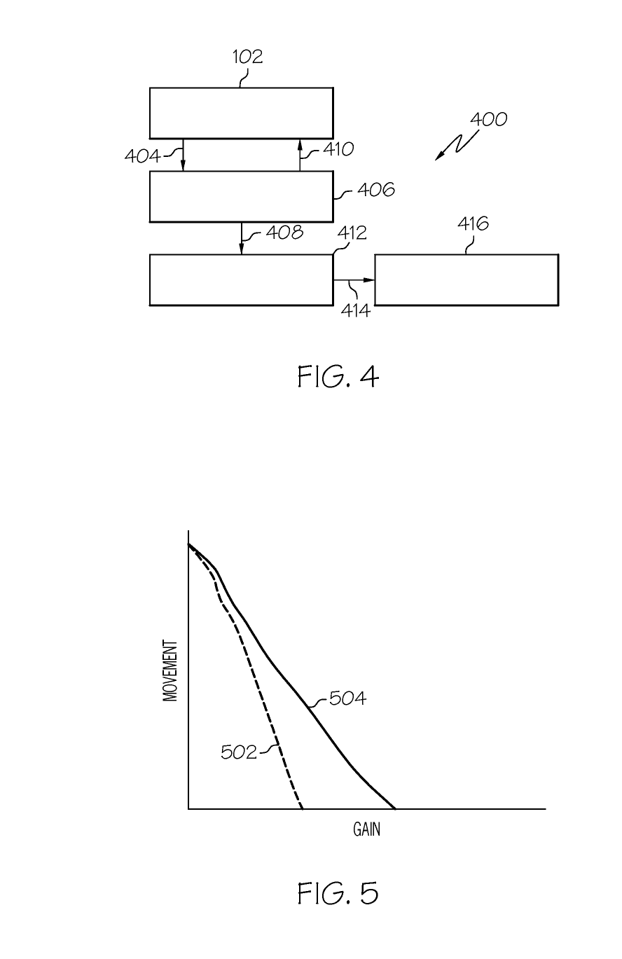

While the embodiments described herein may be used in electronic devices in general, a block diagram of an electronic device 400 as an example using the knob input device 100 is depicted in FIG. 4. A controller 406 provides drive signals 410 to the knob input device 102 (more specifically the touch sensing layers 108), and a sense signal 404 is provided from the knob input device 102 to the controller 406, which periodically provides a signal 408 of the distribution of pressure to a processor 412. The processor interprets the controller signal 408, determines a function in response thereto, and provides a signal 414 to a functional device 416. Although the functional device 416 is shown in this exemplary embodiment, other types of devices or systems, such as a mapping system, may receive the signal 414.

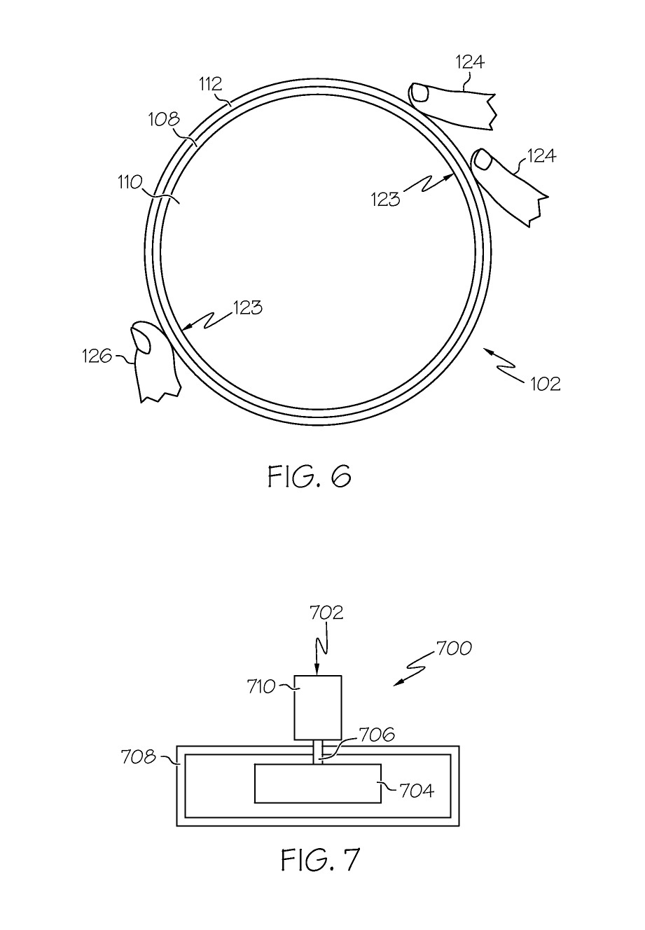

In operation, the sensing layers 108 of the first exemplary embodiment sense (FIG. 2) the position of fingers 120 and the thumb 122 applied in a first position by the user. The fingers 120 sensed may be a single finger or up to four fingers. As the fingers 120 and thumb 122 move on the surface of the knob 102, a gain 502 is provided as illustrated in FIG. 5. When the fingers 124 and thumb 126 are positioned on the knob 102 in a second position as illustrated in FIG. 6, a gain 504 is provided.

Referring to FIG. 7, a second exemplary embodiment includes a knob 702 rotationally mounted to an electronic device 704 by an axial rod 706. The axial rod 706 may pass through a optional housing 708 in which the electronic device 704 may be disposed. The knob 702 and axial rod 706 may be comprised of any rigid material, for example, plastic, rubber, or metal. When the knob 702, and the axial rod 706 securely mounted thereto, are rotated by a user turning the knob 702, a rotation sensing device (not shown) such as a rheostat within the electronic device 104 senses this rotation and converts it to an electronic signal indicative of the amount of rotation. In accordance with the preferred embodiments, touch sensing layers 710 are disposed on the outer surface of the rigid material of knob 702 for detecting the placement of fingers on the knob 702 in a similar fashion to the first embodiment described above. When fingers and thumbs are positioned in a first position on the knob 702 a first gain is provided to the rotation and when the fingers and thumbs are positioned in a second position on the knob 702, a second gain is provided.

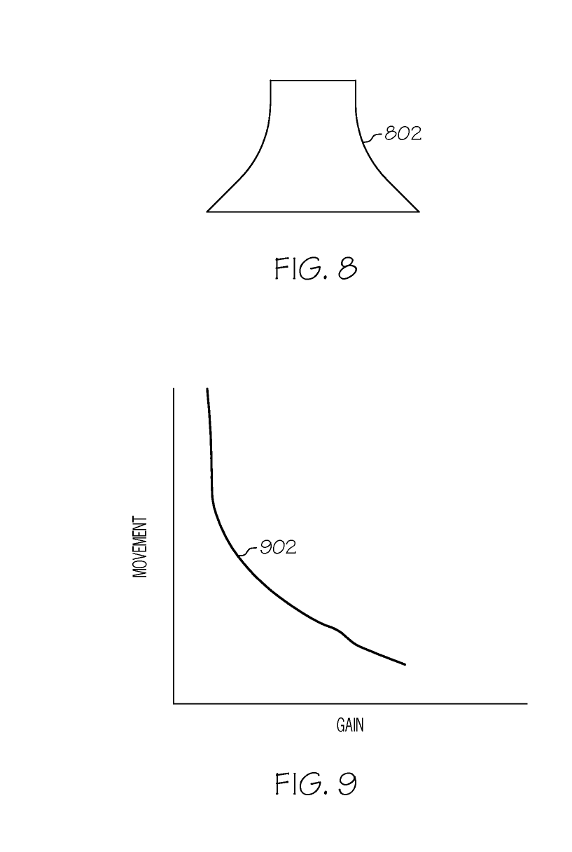

Referring to FIGS. 8 and 9, a third exemplary embodiment includes the knob 802 that has a shape similar to the gain curve 902 (FIG. 9) that it provides.

In a fourth embodiment, a thin layer comprising a texture, for example, a semi-flexible layer containing electro-rheological or magneto-rheological fluid, that varies in proportion to the amount of pressure results in a variable degree of ease in which the fingers moves across the surface. This fluid changes in viscosity proportional to electric or magnetic field. So as more pressure is applied, the gain changes, and a corresponding electro or magnetic field is applied to the fluid and the viscosity increases, making it harder to move across the surface. This increase or decrease in texture and ease of finger movement is sensed by the finger's touch. This textured layer preferably comprises the protective layer 112.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims.

1. An input device comprising:
a knob comprising a material that senses the position of fingers applied thereto and provides a first signal indicative of the position; and
circuitry coupled to receive the first signal that provides an output signal for determining the format for the presentation of information.

2. The input device of claim 1 wherein the material senses movement of the fingers on the knob and the first signal indicates the movement.

3. The input device of claim 1 wherein the material senses the direction of movement of the fingers on the knob and the first signal indicates the direction.

4. The input device of claim 1 wherein the material senses the speed of movement of the fingers on the knob and the first signal indicates the speed.

5. The input device of claim 1 wherein the material is disposed around an axis and movement of the knob along the axis provides a second signal to the circuitry.

6. The input device of claim 1 further comprising a rod coupled between the knob and the circuitry, wherein rotation of the knob causes the rod to rotate, and the circuitry determines an amount of rotation exhibited by the rod.

7. An input device comprising:
a knob including:
a rigid material defining an axis and having a surface opposed to the axis; and
touch sensing layers disposed on the surface that senses the position of one or more fingers applied thereto, the touch sensing layers providing a first signal indicative of the position of the one or more fingers applied thereto; and
an electronic device coupled to receive the first signal and determining the format for the presentation of information based on the position of the one or more fingers on the touch sensing layers.

8. The input device of claim 7 wherein the touch sensing layers comprise:
at least first and second layers that sense movement of the one or more fingers.

9. The input device of claim 8 wherein the touch sensing layers comprise:
at least a third layer for sensing a force applied by the one or more fingers.

10. The input device of claim 7 wherein the touch sensitive layers further comprise:
a textured layer disposed on the touch sensing layers that changes in texture in response to pressure from the one or more fingers.

11. The input device of claim 7 wherein the touch sensing layers further sense the direction of movement of the one or more fingers on the knob and the first signal indicates the direction.

12. The input device of claim 7 wherein the touch sensing layers sense the speed of movement of the one or more fingers on the knob and the first signal indicates the speed.

13. The input device of claim 7 wherein the material is disposed around an axis and movement of the knob along the axis provides a second signal to the circuitry.

14. The input device of claim 7 wherein the knob comprises a shape similar to a gain curve provided by the output signal.

15. A method of providing input to an electronic device, comprising:
sensing the position of fingers on a knob; and
providing a signal that determines the format for the presentation of information based on the position of the fingers.

16. The method of claim 21 further comprising sensing movement of the fingers on the knob and the signal further indicates the movement.

17. The method of claim 21 further comprising sensing the direction of movement of the fingers on the knob and the signal further indicates the direction.

18. The method of claim 21 further comprising sensing the speed of movement of the fingers on the knob and the signal further indicates the speed.

19. The method of claim 21 wherein the movement of the fingers is a rotation around an axis and further comprising sensing movement along the axis and the signal is further indicative thereof.

20. The method of claim 1 wherein the knob comprises a surface having a texture, further comprising varying the texture in response to pressure exerted by the fingers.
